(19) United States
(12) Patent Application Publication
(10) Pub. No.: US 2016/0207645 A1
(43) Pub. Date: Jul. 21, 2016

(54) METERING APPARATUS

(71) Applicant: Harro Hoefliger Verpackungsmaschinen GmbH, Allmersbach im Tal (DE)

(72) Inventors: Hermann Meyer, Allmersbach im Tal (DE); Sven Brecht, Allmersbach im Tal (DE)

(21) Appl. No.: 15/081,725

(22) Filed: Mar. 25, 2016

Related U.S. Application Data
(63) Continuation of application No. PCT/EP2014/002603, filed on Sep. 25, 2014.

(30) Foreign Application Priority Data
Sep. 25, 2013 (DE) 20 2013 008 523.1

(51) Int. Cl. B65B 1/36; G01F 11/18

(52) U.S. Cl. CPC B65B 1/36; G01F 11/18

(57) ABSTRACT

The metering apparatus for the volumetric metering of pourable filler includes a housing and a metering slider which is movable relative to the housing. The housing and the slider conjointly define a metering chamber. The slider is configured as a vertical slider with a stroke axis. The housing includes a guide surface for the slider which extends in the direction of the stroke axis. The slider has a boundary surface corresponding to the guide surface and abuts in a sliding manner against the guide surface. A metering recess is introduced into the slider proceeding from the boundary surface and/or into the housing proceeding from the guide surface. With the slider in a stroke position wherein the metering recess is covered by the guide surface and/or by the boundary surface, the metering chamber is formed by the metering recess, the guide surface and/or the boundary surface.

### CROSS REFERENCE TO RELATED APPLICATIONS

This application is a continuation application of international patent application PCT/EP2014/002603, filed Sep. 25, 2014, designating the United States and claiming priority from German application 20 2013 008 523.1, filed Sep. 25, 2013, and the entire content of both applications is incorporated herein by reference.

### FIELD OF THE INVENTION

The invention relates to a metering apparatus for the volumetric metering of pourable filler.

### BACKGROUND OF THE INVENTION

Volumetric metering is commonly undertaken for the metering of dry, pourable filler, such as powder, granulated material or the like, in particular in the area of washing and cleaning detergents, pharmaceutics or food supplements, by means of which volumetric metering a part quantity of the filler is volumetrically delimited and then transferred into a target cavity (container, capsule, et cetera).

In the case of so-called chamber metering, a housing and a metering slide, which is movable relative to the housing, are provided for this purpose, the housing and the metering slide together defining a metering chamber. The filler, in this case, flows into the metering chamber which determines the quantity of powder or granulated material to be dosed as a result of its volume. The metering slide is movable horizontally in the usual configurations of such metering apparatuses. A feed opening present in the housing is closed, in this connection, as a result of the metering slide moving horizontally and at the same time the metering chamber moving away from the feed opening. By way of the same horizontal movement, the metering chamber is moved to coincide with an outflow opening of the surrounding housing, as a result of which the metering chamber is open at the bottom. The filler flows or trickles out of the chamber into the receptacle to be filled.

As a result of the horizontal movement, a lateral offset is necessary between the feed and outflow openings in which the filler is completely delimited and consequently dosed, which entails a considerable amount of space required at the side. In the case of multi-row filling points for the simultaneous filling of target containers that are arranged in several rows, the use of such a doser is consequently limited or even excluded. In addition, it must be mentioned that a small quantity of powder always escapes to the side during the horizontal movement. The quantity accumulates and has to be sucked up manually again and again at certain time intervals, which results in a reduction in production times. Adapting the volume of the metering chambers to the desired target volumes of the powder or of the granulated material when requirements change is costly in time and money. Between the horizontally moved metering slide and the housing are large-area sliding surfaces which rub against one another during the named relative movement. Powder or dust is able to pass between the sliding surfaces, which increases friction and promotes wear. When the filler in the cavity to be filled has additionally to be compacted, this is also difficult in the case of metering with a horizontal closure. In addition, it is not always possible to avoid the filler trickling in an unwanted manner out of the metering chamber.

### SUMMARY OF THE INVENTION

It is an object of the invention to provide a metering apparatus having a more compact configuration wherein the need for cleaning is reduced.

According to the invention, it is provided that the metering slide is developed as a vertical slide with a stroke axis that is vertical in a usual operating position, that the housing includes a guide surface for the metering slide which extends in the direction of the stroke axis, and that the metering slide includes a boundary surface which corresponds with the guide surface and abuts in a sliding manner against the guide surface. Proceeding from the boundary surface a metering recess is introduced into the metering slide and/or proceeding from the guide surface a metering recess is introduced into the housing, wherein with the metering slide in a stroke position in which the metering recess is covered by the guide surface and/or by the boundary surface, the metering chamber is formed by the metering recess, the guide surface and/or the boundary surface.

In a corresponding operating method according to the invention, the metering slide, which is realized as a vertical slide, is first of all moved into a starting position in which the metering recess is at least in part not covered by the guide surface and/or the boundary surface. With the vertical slide in the starting position, the granulated material or a similar filler trickles out of a storage container into the metering recess. Proceeding from this, the vertical slide is first of all moved into a middle position in which the open side of the metering recess is completely covered by the guide surface and/or by the boundary surface. At the same time, the guide surface abuts in a sealing manner against the boundary surface of the metering or vertical slide above and below the metering recess. In this state, a metering chamber which is precisely defined geometrically with regard to its volume is formed by the metering recess and the inner guide surface which is completely filled with the pourable filler. As a result, a part quantity of the filler is defined, the volume of which corresponds to the volume of the metering chamber.

As a result of a further vertical stroke movement of the metering slide into a third position, the metering recess exits from its cover at least in part such that the measured part quantity of the filler contained in the metering recess is able to trickle out completely and passes as a volumetrically dosed unit quantity into a target cavity located below it. The metering slide is then moved back again into its starting position described above, from which a further metering operation can be carried out with the above-described method steps.

The metering apparatus according to the invention is simple in configuration and can be produced in a cost-efficient manner. As just a vertical stroke movement of the metering slide is necessary, the arrangement with regard to its lateral directions, which are located transversely with respect to the vertical stroke axis, is very compact. As no space is necessary for lateral stroke movements, several combinations of vertical slides and associated guide openings can be arranged closely side by side. Target containers that are located close together are able to be filled at the same time. The aforementioned applies to all lateral directions such that even several rows of target containers that are located close together, for example in a matrix-shaped arrangement, are able to be filled at the same time.

On account of the pure vertical movement of the metering slide, only small-area friction pairings are generated between the inner guide surface of the guide opening realized in the housing and the outer boundary surface of the metering slide. The corresponding surfaces can be matched precisely to one another geometrically at little expense such that the ingress of wear-increasing powder or dust can be suppressed, at least, however, reduced to a minimum. It must also be emphasized that as a result of the configuration according to the invention being closed in the lateral and radial direction, no powder can be lost in the lateral direction as in the prior art. Maintenance and cleaning expenditure are reduced to a minimum. The yield of the prepared filler is maximized.

Less wear is generated overall. Over and above this, the vertical slide is smaller and consequently its mass is smaller compared to horizontal slides according to the prior art such that high cycle rates are able to be run.

In a preferred embodiment, a guide opening, which extends along the named stroke axis, is realized in the housing with an inner guide surface for the metering slide. The metering slide comprises an outer boundary surface which corresponds with the inner guide surface. A metering recess is introduced into the metering slide proceeding from the outer boundary surface. With the metering slide in a stroke position in which the metering recess is completely covered by the inner guide surface, the metering chamber is formed by the metering recess together with the inner guide surface. A compact, coaxial configuration is created where the metering slide can also be used as a compaction element. Where little space is required at the side, a plurality of individual metering apparatuses can be arranged close together in order in this way to fill target cavities which are located close together.

In a further advantageous embodiment, the housing includes a central metering journal, which extends along the stroke axis, with an outer guide surface for the metering slide, wherein the metering slide is realized as a metering sleeve which surrounds the metering journal in the circumferential direction and comprises an inner boundary surface which corresponds with the outer guide surface. Proceeding from the outer guide surface, the metering recess is introduced into the guide journal, wherein with the metering sleeve in a stroke position in which the metering recess is covered by the inner boundary surface, the metering chamber is formed by the metering recess and the inner boundary surface. The metering stroke movement of the outside metering sleeve is separate from a subsequent compaction operation. An optional compaction movement of the central guide journal has no disadvantageous reciprocal effect on the filling and metering operation.

In the case of a further expedient embodiment, realized in the housing is an annular gap, which extends along the stroke axis and is defined on the inside by a central guide journal with an outer guide surface as well as on the outside by a housing outside part with an inner guide surface for the metering slide. The metering slide is realized as a metering sleeve which is guided in a sliding manner in the annular gap and comprises an inner boundary surface which corresponds with the outer guide surface as well as an outer boundary surface which corresponds with the inner guide surface. At least one metering recess is formed by a window which breaks through the metering sleeve, wherein with the metering sleeve in a stroke position in which the at least one metering recess is covered by the inner and the outer guide surface, the metering chamber is formed by the metering recess, the inner guide surface and the outer guide surface. An outflow channel which corresponds with the window is realized in the housing outside part. In this case too, the potentially disadvantageous reciprocal effect between, on the one hand, metering and filling and, on the other hand, compaction is non-existent. In addition, several target cavities can be filled simultaneously and the filling compacted or homogenized using only one metering apparatus.

It can be expedient to produce the metering slide, which is realized as a vertical slide, for example from a flat material with a rectangular cross section. In this connection, the possibility arises of arranging one or several metering recesses on one or two sides which are located opposite with reference to the stroke axis. In a preferred manner, the metering slide is realized as a rotation body with reference to the stroke axis, wherein it extends around the metering recess in a ring-shaped manner and, in this case, divides the boundary surface and/or the guide surface into a bottom surface portion and a top surface portion. Accordingly, the corresponding guide surface or the corresponding boundary surface is developed in a cylindrical manner. As a result of the development as a rotation body, very precise production tolerances can be achieved at little expense. As a result, the desired metering volume is adjustable in a precise manner. Then again, on account of the high level of production accuracy and on account of the lack of corners and edges, precisely defined friction pairings can be produced between the guide surface and the boundary surface and these comprise further reduced wear in operation.

Different, almost arbitrary forms can be considered for the geometric development of the metering recess. In a preferred manner, the metering recess comprises a bottom cover surface and a top cover surface, when viewed in the longitudinal section of the metering apparatus, the bottom cover surface runs out of the metering recess at an angle and/or the top cover surface runs into the metering recess at an angle. In the case of a top cover surface which is angled in such a manner, with the metering slide in the inflow position, the flow of the pourable filler into the metering recess is promoted, whereas with the metering slide in the outflow position, the flow of the filler out of the metering recess is also promoted by the angled bottom cover surface.

In an advantageous further embodiment of the invention, a sealing seat is provided below the guide opening in the housing, wherein a sealing surface, which corresponds to the sealing seat, in a preferred manner is angled and in particular conical, is realized below the metering recess on the metering slide. As once the metering and filling of the target cavity have been carried out, the metering slide is raised again to its starting position, the sealing surface thereof then abuts against the sealing seat. Powder residue trickling out is reliably suppressed such that the metering accuracy is able to be increased even further. Such powder residue is additionally prevented from trickling, for example, onto sealing surfaces of blister packages or the like such that once the metering and filling has been carried out, the target container can be closed in a reliable and sealed manner. In addition, the angled sealing surface and the angled sealing seat are self-cleaning as the corresponding top surfaces are angled in the direction of flow of the filler and the filler consequently automatically follows gravity.

In an advantageous embodiment, the housing and/or the metering slide includes a bottom slide part and a top slide part, wherein a bottom cover surface of the metering recess is realized on the bottom slide part and a top cover surface of the metering recess is realized on the top slide part. The relative positions of the bottom slide part (18) and the top slide part (19) are adjustable with respect to one another measured in the direction of the stroke axis (5). As a result, a volume of the metering recess or of the metering chamber, and consequently of the metering quantity of the filler, is able to be adapted with simple means in dependence on the requirement.

Depending on the requirement, it can be practical for the metering slide to include a compaction punch on its bottom end. As a result of a corresponding vertical stroke of the metering slide, the metering product already filled into the target cavity can be compacted by a desired amount within the same operating cycle.

### BRIEF DESCRIPTION OF THE DRAWINGS

The invention will now be described with reference to the drawings wherein:

FIG. 1 shows a schematic longitudinal sectional representation of a metering apparatus having a housing and having a metering slide which is realized as a vertical slide, wherein the metering slide is raised into a top starting position in which the filler trickles into a metering recess of the vertical slide;

FIG. 2 shows the arrangement according to FIG. 1 with the metering slide in a lowered stroke position in which the metering recess is covered by an inner guide surface of a guide opening of the housing, and in which the metering chamber is formed by the metering recess;

FIG. 3 shows the arrangement according to FIG. 2 with the metering slide lowered further, the filler trickling out of the metering recess of the vertical slide into a target cavity;

FIG. 4 shows the arrangement according to FIG. 3 with the metering slide lowered into a bottommost position, a compaction punch realized on the metering slide compacting the filler in the target cavity;

FIG. 5 shows a variant of the arrangement according to FIG. 1 having a fixed inner housing part in the form of a metering journal and having a metering slide in the form of an outside metering sleeve;

FIG. 6 shows the arrangement according to FIG. 5 with the metering sleeve raised for forming the metering chamber;

FIG. 7 shows the arrangement according to FIGS. 5 and 6 with the metering sleeve raised further in its outflow position;

FIG. 8 shows a schematic longitudinal sectional representation of an alternative embodiment of the metering apparatus having a housing and having a metering slide, the metering slide being realized as a metering sleeve guided in an annular gap of the housing and being raised into a top starting position in which the filler trickles into a metering recess of the vertical slide;

FIG. 9 shows the arrangement according to FIG. 8 with the metering sleeve in a lowered stroke position in which several metering recesses in the form of windows of the metering sleeve are covered by an inner guide journal and an outer guide surface of a guide opening of the housing, and in which the metering chambers are formed by the windows in the metering sleeve;

FIG. 10 shows the arrangement according to FIG. 9 with the metering sleeve lowered further, the filler trickling out of the windows of the metering sleeve into target cavities arranged radially outward; and,

FIG. 11 shows the arrangement according to FIG. 10 with radially outer compaction elements in the form of compaction punches which are lowered and compact the filler in the target cavity.

### DESCRIPTION OF THE PREFERRED EMBODIMENTS OF THE INVENTION

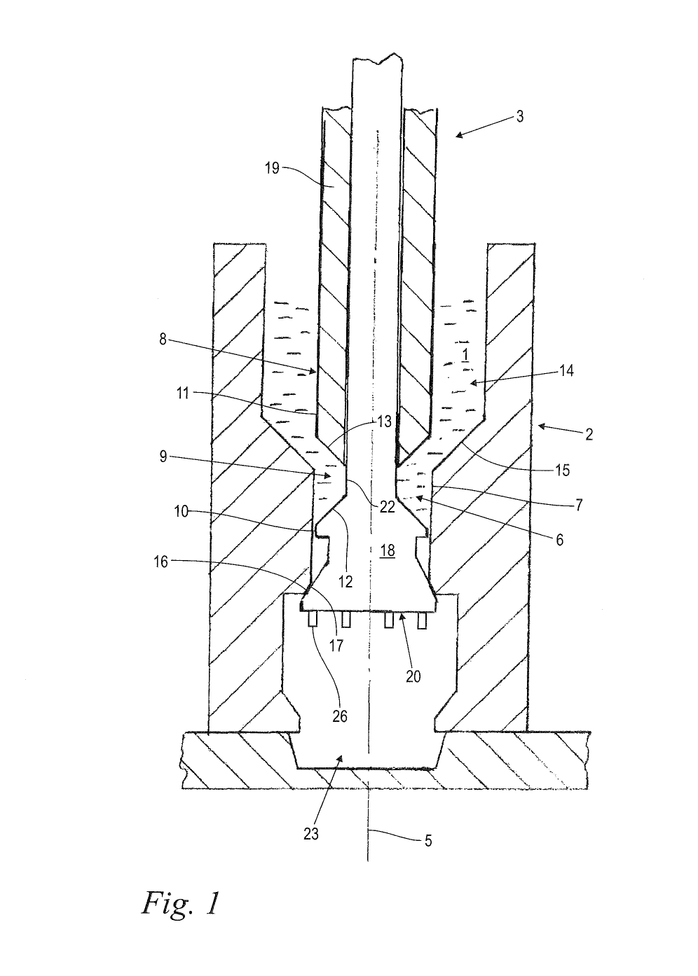

FIGS. 1 to 4 show a schematic longitudinal sectional representation of a first embodiment of a metering apparatus according to the invention in various, consecutive method steps. The metering apparatus is provided for the volumetric metering of pourable filler, in particular of powder or granulated material 1. The dry filler can be a wash detergent, rinse detergent or in general a cleaning detergent, a pharmaceutical filler or, for example, also a food supplement. The granulated material 1 is referred to as an example below, all the explanations also being applicable to other fillers. A part quantity of a larger quantity of the granulated material 1 is set on one side by means of the metering apparatus shown, volumetrically dosed and transferred as a dosed target quantity into a target cavity 23. The target cavity 23 can be a deep-drawn, in particular water-soluble foil package, a flow wrap package, a blister pack, a capsule, a press-opening of a tablet press, an intermediate container or an arbitrary other receiving means.

The metering apparatus includes a housing 2 and a metering slide 3 which is movable relative to the housing 2. The housing 2 is positioned in a stationary manner. The initially empty target cavity 23 is prepared below the housing 2 for the metering and filling operation and once filling has been effected, is replaced for another empty target cavity 23. The arrangement shown, made up of the metering apparatus and the target cavity 23, is shown in its usual operating position. A vertical stroke axis 5 is located almost approximately in the direction of the working load or parallel thereto. The metering slide 3 is realized as a vertical slide, extends along the vertical stroke axis 5 and is displaceable up and down relative to the housing 2 in the direction of the vertical stroke axis 5.

A guide opening 6, which extends along the stroke axis 5 and comprises a constant cross section with a closed circumferential inner guide surface 7 along the stroke axis 5, is realized in the housing 2. The cross section of the guide opening 6 can be, for example, rectangular or polygonal and in the shown preferred embodiment is circular. A cylindrical development of the guide opening 6 follows from the circular cross section in conjunction with the constant cross section along the vertical stroke axis 5.

The metering slide 3 includes an outer boundary surface 8 which corresponds geometrically with the inner guide surface 7 and is surrounded by the inner guide surface 7 completely in the circumferential direction and in part in the direction of the stroke axis 5. In the region of the uninterrupted boundary surface 8, the cross section of the metering slide 3 is therefore identical to the cross section of the guide opening 6, in this case therefore circular. In the case of a vertical stroke movement of the metering slide 3, the outer boundary surface 8 slides in an at least approximately gap-free and play-free manner along the inner guide surface 7 realized in the housing 2.

Proceeding from the outer boundary surface 8, a metering recess 9 is introduced into the metering slide 3. The metering recess 9 can be shaped one side relative to the stroke axis 5. However, several metering recesses 9 can also be provided in the direction of the stroke axis 5 one above another and/or on different sides relative to the stroke axis 5. In the embodiment shown, the metering slide 3 is realized as a rotation body with reference to the stroke axis 5. The metering recess 9 extends around the stroke axis 5 in a ring-shaped manner and at the same time divides the boundary surface 8 into a bottom surface portion 10 and a top surface portion 11. Consequently, the metering recess 9 is defined with reference to the stroke axis 5 at the bottom by a bottom cover surface 12 which proceeds from the bottom surface portion 10, at the top by a top cover surface 13 which proceeds from the top surface portion 11 and radially inward by an inside surface 22. The bottom cover surface 12, the top cover surface 13 and the inside surface 22 extend around the stroke axis 5. Proceeding from the bottom surface portion 10 of the boundary surface 8, the bottom cover surface 12 extends radially inward in the longitudinal section shown and at the same time at an upward angle to the inside surface 22. Consequently, the bottom cover surface 12 runs out of the metering recess 9 at an angle for the subsequent emptying operation for the filler described further below. Proceeding from the top surface portion 11, the top cover surface 13 extends radially inward and at a downward angle to the inside surface 22. Consequently, the top cover surface 13 runs into the metering recess 9 at an angle for the initial filling operation for the filler described further below. It can be practical for only one of the two cover surfaces (12, 13) or none of them to comprise the angled progression. As a result of the angled progression shown, the metering recess 9 is tapered toward the stroke axis 5 proceeding from the outer boundary surface 8 along the stroke axis 5 in the longitudinal section shown.

Along with further structural details, another metering and filling method according to the invention for the granulated material 2 is described below. In a first method step, the metering slide 3 is raised into a top starting position, as is shown in FIG. 1. In this connection, the metering slide 3 is raised until the metering recess 9 protrudes upward at least in part out of the guide opening 6 realized in the housing 2 or above the inner guide surface 7. The top surface portion 11 of the boundary surface 8 has been pulled out of the guide opening 6 completely, while the bottom surface portion 11 of the boundary surface 8 is located inside the guide opening 6 and is closely surrounded by the inside guide surface 7. A storage chamber 14, the cross section of which is greater than the cross section of the metering slide 3 in the region of its boundary surface 8, is realized above the guide opening 6 in the housing 2. As a result, a free connection between the storage chamber 14 and the metering recess 9 is created in the raised starting position shown of the metering slide 3. Filler, here a larger quantity of granulated material 1 which automatically trickles into the metering recess 9 and completely fills the same up on account of the downwardly acting weight force, is stored in the storage chamber 14. An actuator (not shown), which promotes the above-mentioned trickling operating and the complete filling of the metering recess 9, can also be provided as a support.

In addition, the storage chamber 14 includes a bottom 15 which runs radially from out to in and additionally also at a downward angle toward the guide opening 6. This also facilitates the inflow of filler into the metering recess 9 especially in conjunction with the angled top cover surface 13. The angles of inclination of the two cover surfaces (12, 13) and of the bottom 15 relative to the stroke axis 5 are approximately 45° in the embodiment shown and in a preferred manner in each case can be within a range of between 30° and 60°. However, other angles of inclination can also be practical.

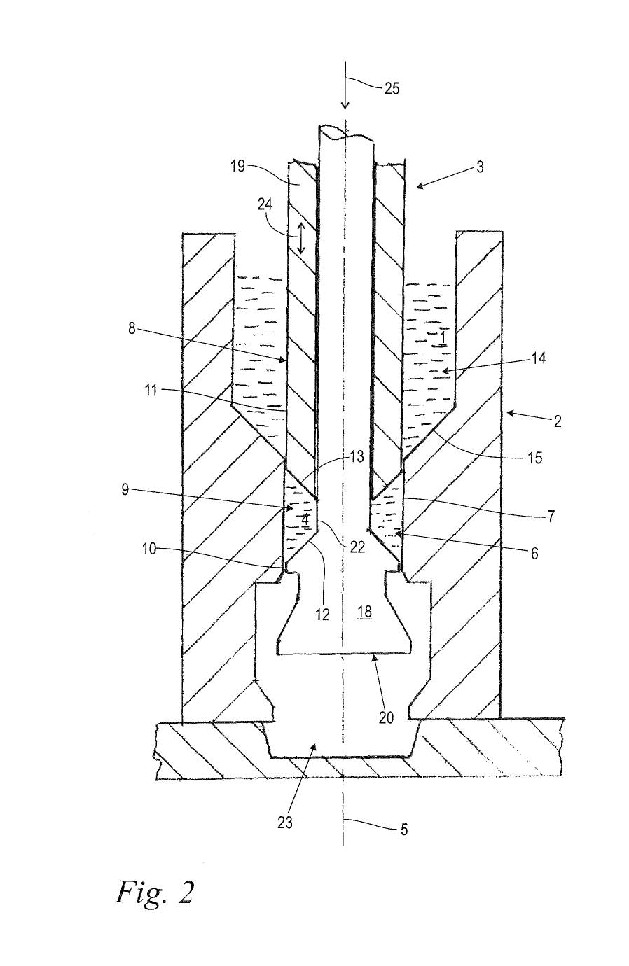

Proceeding from the starting position according to FIG. 1, the metering slide 3, which is realized as a vertical slide, is moved downward corresponding to an arrow 25 in a second method step, initially reaching the relative position with respect to the housing 2 shown in FIG. 2. In the relative position, the radially outer open side of the metering recess 9 is completely covered by the inner guide surface 7 of the guide opening 6. The axial extension of the inner guide surface 7 is greater than the axial extension of the open side of the metering recess 9 such that the guide surface 7 abuts in a sealing manner equally against the bottom surface portion 10 and the top surface portion 11 of the boundary surface 8. In the relative position shown, the metering recess 9 is completely closed. Filler can neither enter nor escape. Rather, the metering recess 9 in conjunction with the guide surface 7 forms a closed metering chamber, which is precisely defined with regard to its volume, is limited by the bottom cover surface 12, the top cover surface 13, the inside surface 22 and the inner guide surface 7 and by means of which a part quantity of the granulated material 1 is measured with the same volume and as a result is volumetrically dosed.

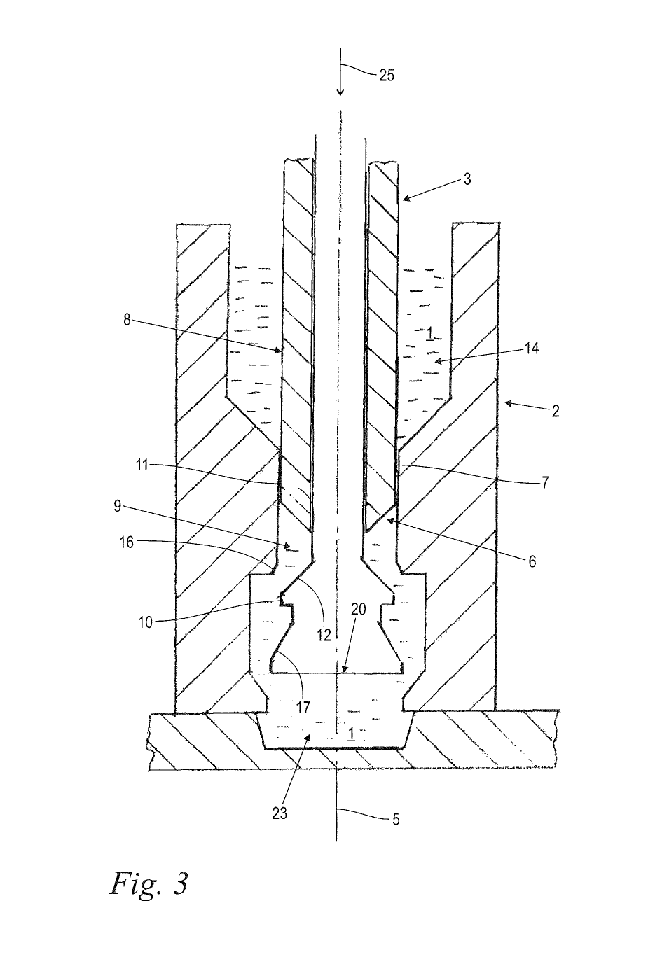

FIG. 3 shows the arrangement according to FIG. 2, the metering slide 3 being displaced further downward in the direction of the arrow 25 relative to its position according to FIG. 2 in the next method step. In this connection, the metering recess 9 projects downward at least in part out of the guide opening 6 or the bottom guide surface 7 until the bottom surface portion 11 is exposed and is no longer surrounded by the guide surface 7. Nonetheless, however, the top surface portion 11 is located sealed in the guide opening 6 such that no granulated material 1 is able to trickle from above. The metering recess 9 is open at the bottom by a gap, here a ring-shaped, opening between the bottom surface portion 11 and the bottom end of the guide opening 6 or a sealing seat 16 realized at that location. The metering chamber 4 shown in FIG. 2 is open. As a result, the volumetrically measured granulated material 1 is discharged out of the metering recess 9 on account of the acting weight force and trickles into the target cavity 23 positioned therebelow. This discharge operation is facilitated by the angled bottom surface cover 12. In order to make this possible, the bottom end 20 of the metering slide 3 is held at a spacing from the target cavity 23. The target cavity 23 is finally filled completely with the volumetrically dosed part quantity of granulated material 1.

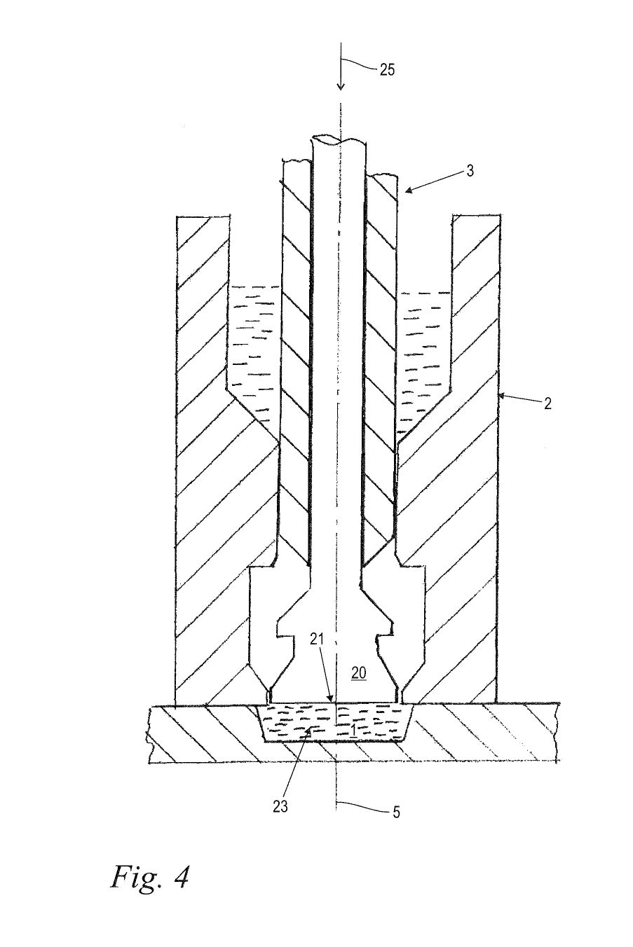

It can be practical as an option for the metering slide 3 to include on its bottom end 20 a compaction punch 21 which is provided in this case with a flat pressing surface located perpendicularly or transversely with respect to the stroke axis 5. FIG. 4 shows, to this end, the arrangement according to FIG. 3, according to which, proceeding from the position according to FIG. 3, the metering slide 3 is lowered even further down in the direction of the arrow 25 in a further optional method step. The pressing or compaction punch 21, in this connection, rests on the granulated material 1 located in the target cavity 23 and compacts it in a desired manner. As an alternative to or in addition to the compaction punch 21, one or several vibration fingers 26, which are shown schematically in FIG. 1 and which project downward beyond the bottom end 20 of the metering slide 3, can be arranged on the bottom surface of the metering slide 3. There are spaces situated between the vibration fingers 26. The metering slide 3 can consequently be lowered until the vibration fingers project into the powder or granulated material filling of the target cavity 23, while the bottom end 20 remains on or above the surface of the filling. In this position, the metering slide 3 then carries out a vertically oscillating pivoting movement which is transmitted into the powder or granulated material filling of the target cavity 23 by means of the vibration fingers 26 and, as a result, homogenizes the filling with a flat surface that in a preferred manner is flush to the edges.

Proceeding from the position according to FIG. 3 or FIG. 4, in which the metering or filling operation has been concluded, the metering slide 3 is raised into its starting position again according to FIG. 1. It can be seen here that a sealing seat 16 is provided in the housing 2 below the guide opening 6, while a sealing surface 17, which corresponds to the sealing seat 16 and in a preferred manner is angled and in this case is conical, is realized on the metering slide 3 below the metering recess 9. When the metering slide 3 is raised into the starting position according to FIG. 1, the sealing surface 17 of the metering slide 3 abuts in a sealing manner against the sealing seat 16 of the housing 2 such that granulated material or powder residues trickling into the target cavity 23 is avoided. Proceeding from the starting position according to FIG. 1, now achieved again, the above-described cycle of method steps can be carried out anew. While the method according to the invention is described above as a sequence of steps, it does not have to be carried out in practice in a stepwise manner, but can rather be effected in an at least partially continuous movement of the metering slide 3.

It can be also seen with renewed reference to FIG. 2 that the metering slide 3 is realized as an option in two parts and here includes a bottom slide part 18 and a top slide part 19. The top slide part 19 does not have to be situated completely above the bottom slide part 18. The difference between the two slide parts as bottom slide part 18 and top slide part 19 is based on the fact that the bottom cover surface 12 of the metering recess 9 is realized on the bottom slide part 18 and the top surface part 13 of the metering recess 9 is realized on the top slide part 19. The top slide part 19 is shown here in a certain relative position with respect to the bottom slide part 18 in the direction of the stroke axis 5, but can be displaced corresponding to a double arrow 24 (FIG. 2) relative to the bottom slide part 18 and the relative position thereof is consequently able to be adjusted. As a result, the axial distance between the top cover surface 13 and the bottom cover surface 12, and consequently the volume of the metering recess 9 or of the metering chamber 4, is able to be varied and adjusted as required.

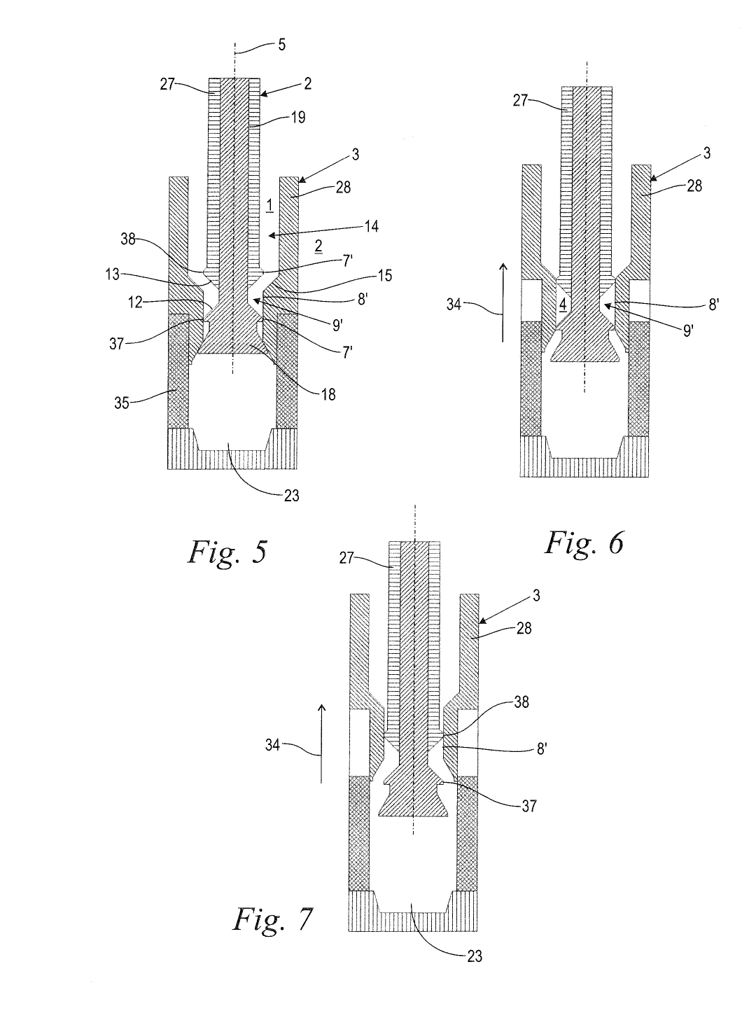

FIGS. 5 to 7 show a schematic longitudinal sectional representation of a variant of the arrangement according to FIG. 1 which operates according to the same operating principle according to the invention; however, the metering slide 3 is not realized as a central vertical slide but as a vertical slide in the form of a metering sleeve 28 which surrounds a central housing part in the form of a metering journal 27. The arrangement shown is surrounded by a housing 2 which is not shown in any detail, simply the central metering journal 27, which is not moved during the metering operation, being shown as part of the housing 2. Departing from the embodiment according to FIGS. 1 to 4, no metering recess 9 is formed in the metering slide 3. Instead of which a metering recess 9′, which extends around in a ring-shaped manner, is introduced into the central metering journal 27.

In its top region, the metering sleeve 28 surrounds the mid region of metering journal 27 at a radial spacing, inside which the storage chamber 14 for the granulated material 1, not shown in any detail, is formed. Here too, the storage chamber 14 includes a ring-shaped circumferential bottom 15 which is realized on the metering sleeve 28 and runs down to the metering recess 9′ at an angle.

Comparable to the embodiment according to FIGS. 1 to 4, it is not the metering slide 3, however, but the metering journal 27 that, as part of the housing 2, includes a bottom slide part 18 and a top slide part 19 with corresponding bottom and top cover surfaces (12, 13). The top and the bottom slide part (18, 19) are adjustable relative to one another in the direction of the stroke axis 5. As a result, the volume of the metering chamber 4 shown in FIG. 6 is adjustable. In addition, the bottom and top cover surfaces (12, 13) are comparable to the embodiment according to FIGS. 1 to 4, running out of the metering recess 9′ at an angle or running into it at an angle. In an analogous manner to this, the bottom cover surface 12 and the top cover surface 13, when seen in the longitudinal section of the metering apparatus, are angled in such a manner that the metering recess 9′ tapers toward the stroke axis 5 proceeding from the outer guide surface 7′ along the stroke axis 5.

When comparing the embodiment according to FIGS. 5 to 7 with that according to FIGS. 1 to 4, an analogous although reversed configuration is also produced in the following aspects set forth below.

The metering journal 27, which extends centrally along the stroke axis 5, includes an outer guide surface 7′, while the metering sleeve 28, which surrounds the metering journal 27 in the circumferential direction, includes an inner boundary surface 8′ which corresponds with the outer guide surface 7′. Accordingly, proceeding from the outer guide surface 7′, the metering recess 9′ is introduced into the metering journal 27. The metering slide 3, which is realized as the metering sleeve 28, and also the metering journal 27 as part of the housing 2 are realized in each case with reference to the stroke axis 5 as rotation bodies, the metering recess 9′ extending around the metering journal 27 in a ring-shaped manner. Because of the ring-shaped development of the metering recess 9′, the outer guide surface 7′ is divided into a bottom surface portion 37 and a top surface portion 38, while the corresponding inner boundary surface 8′ is developed continuously in a cylindrical manner overall.

In a first method step and in the starting position according to FIG. 5, the filler or the granulated material 1 trickles out of the storage chamber 14 into the metering recess 9′. In this connection, the inner boundary surface 8′ only abuts against the bottom surface portion 37, not however against the top surface portion 38 such that the metering recess 9′ is open inward toward the storage chamber 14 and allows the filler to enter. When comparing FIGS. 5 and 6, it can be seen that in a subsequent method step and proceeding from its starting position shown in FIG. 5, the metering sleeve 28 can be raised in the direction of the stroke axis 5 corresponding to an arrow 34. In the then reached middle stroke position corresponding to the representation according to FIG. 6, the metering recess 9′ is completely covered by the inner boundary surface 8′ of the metering sleeve 28. The inner boundary surface 8′ therefore abuts in a sealing manner against both the bottom surface portion 37 and the top surface portion 38 such that an overall closed metering chamber 4 is created formed by the metering recess 9′ and the inner boundary surface 8′. In other words, the interior of the metering chamber 4 is defined and enclosed with a defined volume by the inner boundary surface 8′, the bottom cover surface 12, the top cover surface 13 and the radially inner circumferential wall of the metering recess 9′. The volume of the metering chamber 4 provides the volume of the granulated material 1 to be measured or to be dosed, it being possible to adjust this volume in the manner already described above as a result of positioning the top and the bottom slide part (18, 19) relative to each other in an axial manner.

In the next method step, proceeding from the representation according to FIG. 6, the metering sleeve 28 is raised further in the direction of the arrow 34 until it has reached the position shown in FIG. 7. In the top position, the inner boundary surface 8′ of the metering sleeve 28 exposes the bottom surface portion 37 of the metering journal 27, as a result of which the metering chamber 4 is open at the bottom in a ring-shaped manner. The granulated material 1 contained therein and measured volumetrically trickles through the corresponding gap and on into the target cavity 23 located below. The top surface portion 38 continues to remain covered by the inner boundary surface 8′ such that no filler or granulated material 1 is able to trickle from above.

In an analogous manner to the embodiment according to FIGS. 1 to 4, compaction elements in the form of a compaction punch and/or a vibration element can be arranged on the metering journal 27. The metering journal 27, which is immobile during the above-described metering operation, proceeding from its rest position shown here, can then be lowered toward the target cavity 23 and there carry out a compaction or a homogenization of the filler. The compaction movement of the metering journal 27, which is immobile apart from this, is triggered in this case by the metering movement of the axially movable metering sleeve 28.

However, in the embodiment shown no use is made of the aforementioned option. Rather, the metering apparatus includes on its bottom surface a bridging sleeve 35 which, proceeding from the metering sleeve 28, extends downward and reaches up to the edge of the target cavity located below it. The cross sectional format of the metering apparatus does not consequently have to be in accordance with the outline format of the target cavity 23 such that different target cavities 23 with different forms are able to be filled using the same metering apparatus. In each case, the bridging sleeve 35 ensures that the measured granulated material 1 passes completely into the target cavity 23 irrespective of its format. The compaction of the granulated material 1 inside the target cavity 23 is effected then in a separate method step at a subsequent processing station not shown here.

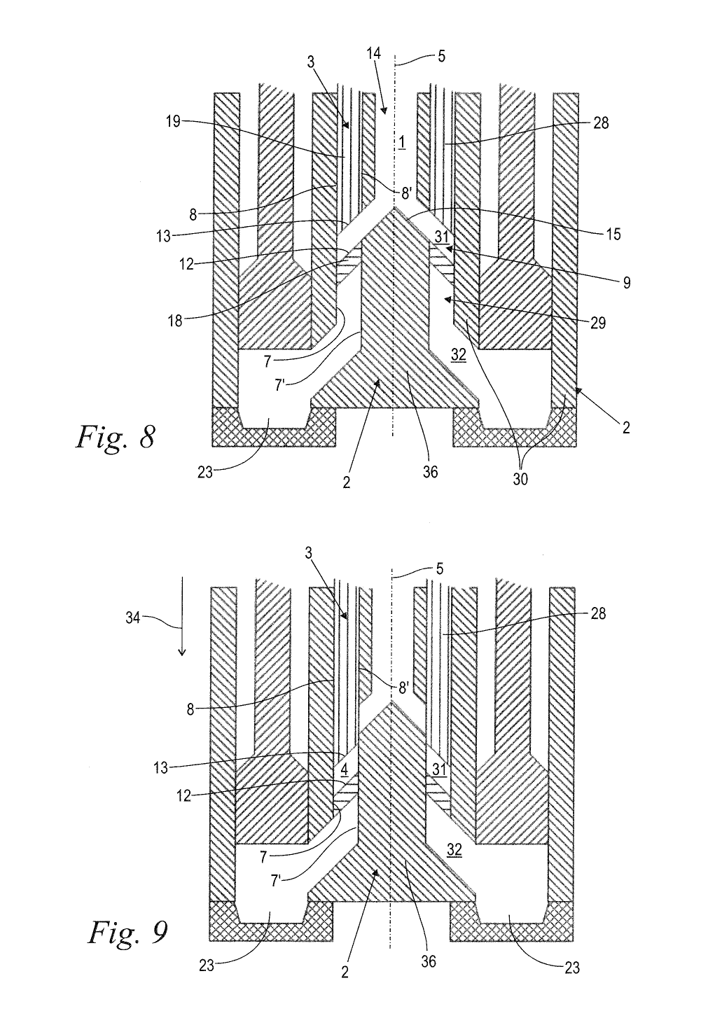

FIGS. 8 to 11 show a further variant of the metering apparatus according to the invention. Here too, the metering slide 3 is realized as a vertical slide with a stroke axis 5 which is vertical in a usual operation position. The housing 2 also comprises guide surfaces (7, 7′), which extend in the direction of the stroke axis 5, for the metering slide 3, while the metering slide 3 comprises boundary surfaces (8, 8′) which correspond with the guide surfaces (7, 7′) and abut in a sliding manner against the guide surfaces (7, 7′). In further agreement with the embodiments previously looked at, proceeding from the boundary surfaces (8, 8′), at least one metering recess 9 is introduced into the metering slide 3, the metering recess 9 comprising a bottom cover surface 12 and a top cover surface 13. With the metering slide 3 in a middle stroke position corresponding to the representation according to FIG. 9, the metering recess 9 is covered by the guide surfaces (7, 7′). In this connection, the metering chamber 4 (FIG. 9) is formed by the metering recess 9 and by the guide surfaces (7, 7′).

In contrast to the aforementioned embodiments, realized in the housing 2 is an annular gap 29, which extends along the stroke axis 5 and is defined on the inside by a central guide journal 36, which is also associated with the housing 2, with an outer guide surface 7′ as well as on the outside by a housing outside part 30 with an inner guide surface 7. The guide surfaces (7, 7′) are developed as coaxial cylinders. The metering slide 3 is realized as a metering sleeve 28 which is guided in a sliding manner in the named annular gap 29 and comprises an inner boundary surface 8′ which corresponds with the outer guide surface 7′ as well as an outer boundary surface 8 which corresponds with the inner guide surface 7.

At least one metering recess 9, which is developed here as a window 31 which breaks through the metering sleeve 28, is formed in the metering sleeve 28. With the metering sleeve 28 in a middle stroke position shown in FIG. 9, the window 31 is covered on the inside by the inner guide surface 7 and at the same time also on the outside surface by the outer guide surface in such a manner that a closed metering chamber 4 is created formed or defined by the window 31, the inner guide surface 7 and the outer guide surface 7′. In other words, the interior the metering chamber 4 is defined and enclosed with a defined volume by the inner guide surface 7, the outer guide surface 7′, the bottom cover surface 12 and the top cover surface 13. Corresponding to this, an outflow channel 32 which runs downward at an angle and radially outward is realized in the housing outside part 30. Several windows 31, which are distributed over the circumference, and a corresponding number of outflow channels 32 which correspond with the windows 31, are provided in the embodiment shown and are arranged distributed around the stroke axis 5.

In an analogous manner to the embodiments looked at beforehand, a storage chamber 14 for the filler is realized above the metering chamber 4 in the housing 2, a bottom 15 of the storage chamber 14 running down at an angle to the metering recesses 9. With consideration to the number of the several metering recesses 9, the angled bottom 15 is developed in a conical manner in the embodiment shown, but can also be developed in the manner of a pyramid or analogously with individual angled surfaces.

Continuing the analogy with the remaining embodiments, the metering slide 3 or the metering sleeve 28 includes a bottom slide part 18 as well as a top slide part 19 with associated top and bottom cover surfaces (12, 13), the relative position of the bottom slide part 18 and the top slide part 19 with reference to one another measured in the direction of the stroke axis 5 being adjustable, and as a result of which the volume of the metering chamber 4 is adjustable in the manner described previously.

FIGS. 8 to 11 show different, associated method steps corresponding to a phase representation. In the first method step according to FIG. 8, the metering sleeve 28 is raised into a starting position in which the metering recesses 9 are covered radially outward by the inner guide surface 7, but not radially inward by the outer guide surface 7′. In this position, the inner guide surface 7 accordingly forms the radially outer wall or boundary of the metering recess 9. In this position, the filler or the granulated material 1 trickles out of the storage chamber 14 into the metering recesses 9 such that the metering recesses 9 are filled with the filler. The filling operation is also promoted as a result of the top cover surface 13, analogously with the embodiments already looked at further above in the longitudinal section shown, being at an angle in such a manner that, proceeding from the storage chamber 14, it runs downward at an angle and radially outward into the metering recess 9.

In the next method step according to FIG. 9, the metering sleeve 28 is lowered corresponding to the arrow 34 until the metering recesses 9 or the windows 31 are covered not only radially outward by the inner guide surface 7′, but also radially inward by the outer guide surface 7 of the middle housing part in the form of the guide journal 36. In this case, by means of their volume which is certainly adjustable, but also fixedly defined geometrically once adjusted, the metering chambers 4 created in this connection provide the volume of the part quantities of the filler or of the granulated material 1 to be measured or to be dosed.

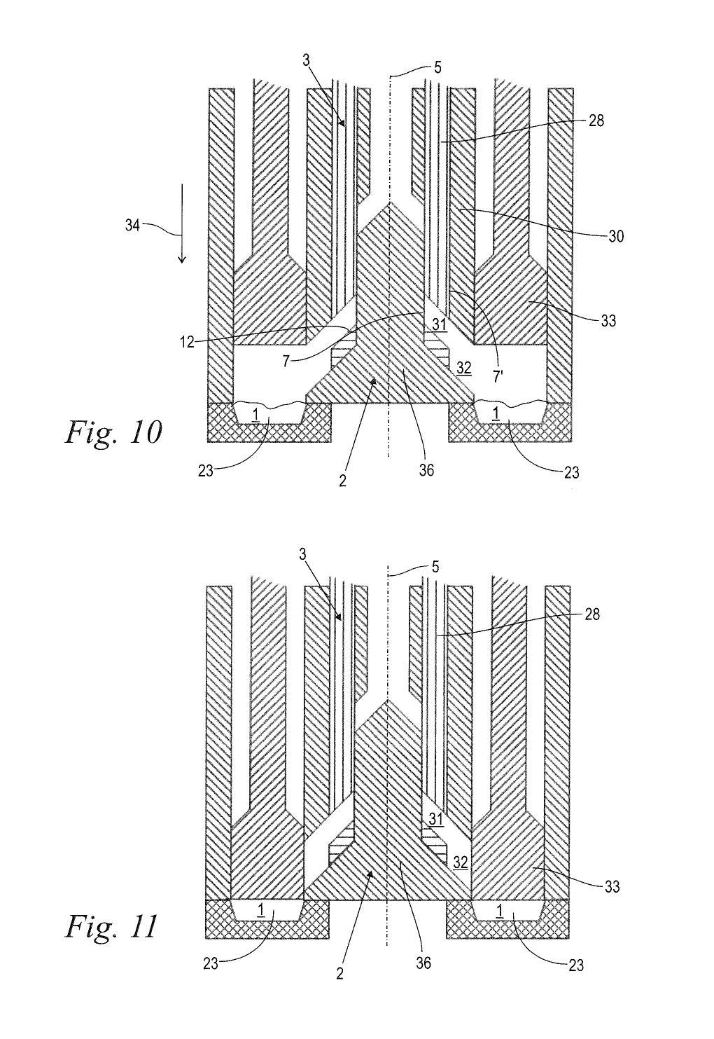

In the subsequent method step, the metering sleeve 28 is lowered further according to the arrow 34, as is shown in FIG. 10. In this connection, the windows 31 come to rest below the inner guide surfaces 7′ of the housing outside part 30 and are situated, in this case, in alignment with the associated outflow channels 32 which are realized in the housing outside part 30, whilst they continue to be closed radially inward by the outer guide surface 7. The outer guide surface 7′ forms here the radially inner wall or boundary of the metering recess 9. In the position according to FIG. 10, the previously dosed filler or granulated material 1 trickles downward out of the metering chambers 4 (FIG. 9) through the outflow channels 32 and at the same time also radially outward into the target cavities 23 which have already been placed below the metering apparatus. The outflow operation is also promoted by the bottom cover surface 12, in an analogous manner to the embodiments already looked at further above in the longitudinal section shown, being angled in such a manner that it causes the filler to flow out of the metering recess 9. Deviating from the above embodiments, however, considering the outflow channels 32 and target cavities 23 arranged radially outside, the bottom cover surface 12 in this case, proceeding from the inner wall of the metering recess 9, runs at a downward angle and radially outward.

In an optional, subordinate method step according to FIG. 11, compaction elements 33, which are arranged on the outside of the respective outflow channel 32, can be lowered toward the target cavities 23 and there compact or homogenize the granulated material 1 inside the target cavities 23. In the embodiment shown, the compaction elements 33 are realized in the form of compaction punches. As an alternative to this or in addition to it, vibration elements or the like, which carry out the named homogenization as a result of a vibration movement, can also be provided in an analogous manner with the embodiment according to FIGS. 1 to 4.

Unless expressly mentioned otherwise, the remaining features, references, method steps and application options of the embodiments shown here are consistent with one another.

It is understood that the foregoing description is that of the preferred embodiments of the invention and that various changes and modifications may be made thereto without departing from the spirit and scope of the invention as defined in the appended claims.

What is claimed is:

1. A metering apparatus for volumetrically metering a pourable filler including granulated powder and pharmaceutical powder, the metering apparatus comprising:
a housing;
a metering slider;
said housing and said metering slider being movable relative to each other and conjointly delimiting a metering chamber;
said metering slider being configured as a vertical slider defining a vertical stroke axis in a usual operating position thereof;
said housing defining a guide surface for said metering slider and said guide surface extending in the direction of said stroke axis;
said metering slider having a boundary surface corresponding to said guide surface and lying with said boundary surface in sliding contact engagement with said guide surface;
a metering recess formed starting from at least one of the following: said boundary surface into said metering slider and said guide surface into said housing; and,
in a stroke position of said metering slider whereat said metering recess is covered by at least one of said guide surface and said boundary surface, said metering chamber being formed by said metering recess and at least one of said guide surface and said boundary surface.

2. The metering apparatus of claim 1, wherein a supply chamber for said filler is formed above said metering chamber; and, said supply chamber has a base configured inclined downwardly toward said metering recess.

3. The metering apparatus of claim 1, wherein at least one of said housing and said metering slider has a lower slide part and an upper slide part; a lower cover surface is formed on said lower slide part and an upper cover surface is formed on said upper slide part; said lower cover surface and said upper cover surface delimit said metering recess; and, said lower slide part and said upper slide part are adjustable relative to each other measured in the direction of said stroke axis.

4. The metering apparatus of claim 1, wherein said metering recess has a lower cover surface and an upper cover surface; said lower cover surface is inclined out of said metering recess and/or said upper cover surface is inclined into said metering recess when viewed in a longitudinal section of said metering apparatus.

5. The metering apparatus of claim 1, wherein a guide opening having an inner guide surface for said metering slider is configured in said housing; said guide opening extends along said stroke axis; said metering slider has an outer boundary surface corresponding to the inner guide surface; and, said metering recess is introduced into said metering slider starting from said outer boundary surface; and, in a stroke position of the metering slider whereat said metering recess is covered by said inner guide surface, said metering chamber is configured by said metering recess and said inner guide surface.

6. The metering apparatus of claim 5, wherein said metering slider is configured as a rotational body with reference to said stroke axis; said metering recess has an annular shape about said stroke axis and subdivides said outer boundary surface into a lower surface section and an upper surface section; and, said inner guide surface of said guide opening is configured to be cylindrical.

7. The metering apparatus of claim 6, wherein said lower cover surface and/or said upper cover surface are disposed inclined when viewed in a longitudinal section of said metering apparatus so as to cause said metering recess to be tapered toward said stroke axis starting from said boundary surface along said stroke axis.

8. The metering apparatus of claim 7, wherein a sealing seat is provided in said housing below said guide opening; and, said metering slider has a sealing surface formed thereon below said metering recess corresponding to said sealing seat.

9. The metering apparatus of claim 8, wherein said sealing surface is a conical sealing surface.

10. The metering apparatus of claim 8, wherein said metering slider has a lower end whereat a compaction stamp and/or at least one vibration finger is provided.

11. The metering apparatus of claim 1, wherein said housing includes a central metering journal extending along said stroke axis; said guide surface for said metering slider is formed on said metering journal as an outer guide surface; said metering slider is configured as a metering sleeve closed around said metering journal in a peripheral direction; said boundary surface of said metering slider is an inner boundary surface corresponding to said outer guide surface; and, said metering recess is introduced into said metering journal starting from said outer guide surface; and, in stroke position of said metering sleeve whereat said metering recess is covered by said inner boundary surface, said metering chamber is formed by said metering recess and said inner boundary surface.

12. The metering apparatus of claim 11, wherein said metering journal is configured as a rotational body with reference to said stroke axis; said metering recess extends annularly and subdivides said outer guide surface into a lower surface section and an upper surface section; and, said inner boundary surface of said metering sleeve is configured to be cylindrical.

13. The metering apparatus of claim 12, wherein said lower cover surface and/or said upper cover surface are disposed to lie inclined when viewed in longitudinal section of said metering apparatus so as to cause said metering recess to be tapered toward said stroke axis starting from said outer guide surface along said stroke axis.

14. The metering apparatus of claim 1, wherein an annular gap is formed in said housing and extends along said stroke axis; said annular gap is delimited inwardly by a central guide journal having an outer guide surface and outwardly by a housing outer part having an inner guide surface for said metering slider; said metering slider is configured as a metering sleeve slideably guided in said annular gap; said metering sleeve has an inner boundary surface corresponding to said outer guide surface and an outer boundary surface corresponding to said inner guide surface; at least one metering recess is formed by a window broken through said metering sleeve; in a stroke position of said metering sleeve whereat said metering recess is covered by said inner and said outer guide surfaces, said metering chamber is formed by said metering recess, said inner guide surface and said outer guide surface; a discharge channel is formed in said housing outer part; and, said discharge channel corresponds to said window.

15. The metering apparatus of claim 14, wherein a plurality of said windows are formed in said metering sleeve distributed over the periphery thereof; and, a plurality of said discharge channels are formed in said housing outer part corresponding to respective ones of said plurality of windows.

16. The metering apparatus of claim 14, wherein compaction elements are provided at the outside of said discharge channels at corresponding ones thereof.

17. The metering apparatus of claim 16, wherein said compaction elements are configured as compaction stamps and/or a vibration element.

18. The metering apparatus of claim 16, further comprising a lower end and a delivery sleeve at said lower end for connecting to a target cavity.
